(19) United States
(12) Patent Application Publication
(10) Pub. No.: US 2024/0108023 A1
(43) Pub. Date: Apr. 4, 2024

(54) ENZYMATIC SYNTHESIS OF GALACTO-OLIGOSACCHARIDES FROM CONCENTRATED SWEET WHEY PERMEATE AND APPLICATION THEREOF IN DAIRY PRODUCTS

(71) Applicant: ALPINA PRODUCTOS ALIMENTICIOS S.A. BIC, SOPO (CO)

(72) Inventors: Bernadette Francisca KLOTZ CEBERIO, Bogotá (CO); David ORREGO LÓPEZ, Chía (CO)

(21) Appl. No.: 18/478,591

(22) Filed: Sep. 29, 2023

(30) Foreign Application Priority Data
Sep. 30, 2022 (CO) NC2022/0014022
Dec. 21, 2022 (CO) NC2022/0018618

(51) Int. Cl. A23C 21/02; A23L 7/10; A23L 19/00; B01D 61/02; B01D 61/14; B01D 61/58

(52) U.S. Cl. CPC A23C 21/023; A23L 7/10; A23L 19/09; B01D 61/027; B01D 61/145; B01D 61/58; A23C 2210/206; B01D 2311/06; B01D 2311/08; B01D 2315/16

(57) ABSTRACT

After whey protein concentration and recovery by ultrafiltration, the lactose in the permeate is further concentrated by nanofiltration, resulting in a retentate used as a substrate for enzymatic production of GOS by a β-galactosidase enzyme. A GOS ingredient is obtained, characterized by having between 30 and 95% of GOS, which could improve the organoleptic properties (in terms of texture and flavor) of the products in which it is applied, and also giving it prebiotic properties.

### TECHNICAL FIELD OF THE INVENTION

The present disclosure pertains to the food industry, specifically to a method for the production of a galacto-oligosaccharide (GOS) ingredient and formulations of the GOS ingredient from cheese whey.

### DESCRIPTION OF THE PRIOR ART

By 2019, cheese whey production reached a total of 21,600,000 tons globally, and even though several strategies are applied to make the most of this whey, there is still a concern about the environmental problems generated by its unproper disposition, especially due to the high biological oxygen demand (BOD) of this industry. Among the components in cheese whey, whey protein, lactose, fat, and minerals represent the majority of solids present. Fat is normally removed in equipment to defat milk, which is common in dairy-processing plants; however, the separation of protein, lactose, and minerals represents a bigger challenge. Valorization of by-products in the dairy industry as a strategy to promote circular economies has become a priority around the globe. Cheese whey and its derivates from filtration technologies offer a source of valuable molecules such as proteins, fat, lactose, and minerals.

Bearing in mind the technological and economic advantages of fractioning the components in whey, tangential filtration gives the opportunity to separate said components, from lab scale to industrial set-ups. Using ultrafiltration membranes, with a molecular weight cut-off (MWCO) of 10 kDa, protein concentration in whey became possible, enabling opportunities to use this stream as an ingredient in dairy industries or as raw material for production of protein concentrates such as whey protein concentrate (WPC), whey protein isolate (WPI) or whey protein hydrolysate (WPH).

The permeate from ultrafiltration, rich in lactose (4-5%) and minerals can be concentrated by nanofiltration, where the size of the pores in the membranes allows us to retain the lactose and some of the minerals, increasing the concentration of the carbohydrate up to 20-25%. This stream is underutilized by many dairy industries; however, lactose can be used as a substrate for multiple fermentative and enzymatic processes to valorize this byproduct.

One of the options explored for utilization of whey permeate is the production of galactooligosaccharides (GOS) from lactose, as shown in Eskandarloo, H. and Abbaspourrad, A., “Production of Galacto-Oligosaccharides from Whey Permeate Using β-Galactosidase Immobilized on Functionalized Glass Beads,” Food Chem., vol. 251, no. December 2017, pp. 115-124, 2018, and Das, R.; Sen, D.; Sarkar, A.; Bhattacharyya, S. and Bhattacharjee, C., “A Comparative Study on the Production of Galacto-Oligosaccharide from Whey Permeate in Recycle Membrane Reactor and in Enzymatic Batch Reactor,” Ind. Eng. Chem. Beef., vol. 50, no. 2, pp. 806-816, 2011.

GOS are oligomers of glucose connected to galactose chains of different lengths, normally between 3 and 10 monomers per molecule. Production of these oligomers has been evaluated through chemical synthesis with poor opportunities for industrial scale-up; hence, the use of β-galactosidase has become the most popular method to generate GOS. β-galactosidases are enzymes commonly used by the food industry to hydrolyze lactose in dairy products, looking to reach lactose intolerant consumers.

However, these enzymes have an alternative transferase activity known as transgalactosylation, able to use lactose, or other carbohydrates, as an acceptor of galactosyl units, forming oligomers with different degrees of polymerization (DP). Different microorganisms have been studied as a source of β-galactosidases for GOS production, including strains of Kluyveromyces, Aspergillus, Bacillus y Bifidobacterium on a laboratory scale. However, commercial enzymes designed for GOS production are now available to be used in dairy products, aiming to reduce lactose content and generate prebiotic fiber.

A prebiotic effect has been attributed to GOS molecules given the specific effect on growth promotion of probiotic bacteria, primarily strains from the Bifidobacteria and Lactobaccillus genus. Several studies, such as those carried out by Liu, Y.; Gibson, G. R.; and Walton, G. E. in “An in Vitro Approach to Study Effects of Prebiotics and Probiotics on the Faecal Microbiota and Selected Immune Parameters Relevant to the Elderly,” PLoS One, vol. 11, no. 9, pp. 1-18, 2016, have evaluated different prebiotic effects generated by the consumption of GOS, including the improvement of colonic health in breast-fed infants, and reduced risk of colon cancer and enhanced immunity in older consumers. Specifically, infant food products such as formulas, include a mixture of GOS and FOS (fructo-oligosaccharides) given the resemblance on the gut microbiota formation when compared to breastfed infants. Besides the prebiotic benefits of GOS, some technological advantages when applying GOS ingredients in food products have been identified, including improvements in mouthfeel, creaminess, and sweetness, as shown in Sangwan, V.; Tomar, S. K.; Singh, R. R. B.; Singh, A. K.; and Ali, B., “Galactooligosaccharides: Novel Components of Designer Foods”, J. Food Sci., 2011, 76, R103-R111.)

Given the attributes of GOS, in this study, an alternative process to generate an unrefined GOS syrup from concentrated whey permeate has been developed, and its application on a dairy product was tested to identify possible organoleptic changes and determine its potential as an ingredient in the food industry.

A lactose-rich medium was produced by nanofiltration of whey permeate in an industrial set-up, serving as substrate for GOS formation using a commercial enzyme. The GOS yield and length distribution of the oligomers generated were determined to select the conditions that maximize GOS production. These conditions were replicated to generate a GOS syrup that was applied in a dairy porridge and evaluated in a blind sensory test compared to a control product. Results showed a high formation of GOS for the substrate-enzyme system studied in this work, with an improvement in the texture and flavor of the dairy product supplemented with the GOS syrup. In-house generation of functional ingredients such as GOS, using by-products with low or no cost to manufacturers could represent a game-changing strategy in sustainable food fractionation for food industries in developing countries and/or emerging businesses.

### BRIEF DESCRIPTION OF THE DRAWINGS

FIG. 1. Process flow diagram.

FIG. 2a. GOS yield achieved at different time points during the enzymatic reaction with an addition of 57 LAU/g of solution. Bars with different letters represent statistical difference, with a p-value of 0.05.

FIG. 2b. GOS yield achieved at different time points during the enzymatic reaction with an addition of 28 LAU/g of solution.

FIG. 3a. Distribution of carbohydrates in solution during the enzymatic production of GOS with an addition of 57 LAU/g of solution. Identified carbohydrates include galactose, glucose, lactose, and GOS with degrees of polymerization 2 (DP2), 3 (DP3), and 4 (DP4).

FIG. 3b. Distribution of carbohydrates in solution during the enzymatic production of GOS with an addition of 28 LAU/g of solution. Identified carbohydrates include galactose, glucose, lactose, and GOS with degrees of polymerization 2 (DP2), 3 (DP3), and 4 (DP4).

### DETAILED DESCRIPTION

The present development is related to an enzymatic process to obtain a GOS ingredient and the GOS ingredient obtained therefrom. This development describes an alternative process for the valorization of whey permeate to produce GOS ingredients that can be used directly in day-to-day dairy products.

### Concentrated Whey Permeate (CWP)

This process begins with the concentration of a whey permeate. “Whey” is the aqueous part of milk that is separated from the coagulable or curdled part, especially in the cheese-making process. The term “permeate” is used here to refer to the fraction of whey that passes through the filtration membrane and contains those components of interest. Therefore, “whey permeate” refers to a product with a high concentration of carbohydrates produced by the removal of proteins and other solids from the whey, which is obtained through a filtration process. The concentrated whey permeate is further characterized in that it comprises carbohydrates, minerals, and water.

Concentration of whey permeate is performed to obtain a product with a high concentration of carbohydrates (lactose) and to obtain a concentrated whey permeate (CWP). Preferably, the whey permeate is obtained through a filtration process which allows obtaining a permeate and a retentate. For example, filtration can be performed by ultrafiltration (UF) to remove the remaining protein and fat in the whey and obtain a permeate containing lactose, minerals, and water. In an additional concentration step, it is possible, for example, to perform nanofiltration (NF) to further concentrate the carbohydrates and, to a lesser extent, minerals, which remain in the retentate of the filtration process.

In an embodiment, the first process step comprises preparing a whey permeate, wherein the whey is passed through an ultrafiltration device and, subsequently, the permeate is passed through a nanofiltration device and optionally through an evaporator. Once the concentration is completed, a concentrated whey permeate (CWP) is obtained. The solids obtained are concentrated to a lactose concentration between 20 and 40% on a wet basis, between 25 and 35% lactose on a wet basis, preferably 30% lactose on a wet basis.

In the ultrafilter, it is suggested that a polysulfone/polyestersulfone polyester spiral membrane be used with a pH working range of 3 to 9, a pressure range of 1 to 10 bar, and temperature range of 0 to 50° C. The ultrafilter has a pore size between 5 and 15 kDa, preferably 10 kDa±2 kDa. The nanofilter has membranes made of the same material mentioned above. In a preferred embodiment, it is suggested that a spiral membrane be used with a pore size between 50 and 500 Da, preferably 100 Da +-10 Da, with a rejection coefficient of 1 for carbohydrates and 0.6 for minerals.

In a preferred embodiment, defatted sweet cheese whey is used to obtain the whey permeate. Sweet whey comes from the enzymatic coagulation of the casein protein of milk; therefore, it does not go through a fermentation process in which part of the lactose present in the medium is consumed and there is no pH reduction due to the production of organic acids. Thus, sweet whey contains a higher concentration of lactose that can be converted into GOS and has a pH close to neutral, at which the enzyme used for GOS production functions under optimal conditions.

In a preferred embodiment, an additional concentration of the solids of interest is performed in a rotary evaporator; it is suggested that it be used under 50 mBar of pressure, 50° C. of temperature, and 40 rpm.

### Enzymatic Reaction

The enzymatic process developed allows obtaining a galacto-oligosaccharide (hereinafter GOS) ingredient from concentrated whey permeate (hereinafter CWP). This step consists of the in situ reaction of the GOS-producing enzyme and the concentrated whey permeate with about 30% lactose in a stirred reactor.

The enzymatic reaction is carried out in reactor equipment and, in one embodiment, the reaction conditions are, among others, temperature between 40 and 70° C., between 45 and 65° C., between 50 and 55° C., between 50 and 60° C., preferably at 55° C. ±2° C.; the reaction must also occur under agitation conditions that will depend on the size of the vessel/reactor and the stirrer, wherein the agitation may be between 1 and 400 rpm, between 5 and 200 rpm, between 5 and 50 rpm, between 100 and 300 rpm; for a time of 0.1 to 5 hours, 1 to 4 hours, preferably of 1 to 2 hours; or those conditions in which the enzyme can react with the concentrated whey permeate.

For purposes of the present disclosure, the GOS-producing enzyme consists of a Bifidobacterium bifidum transgalactosylase enzyme. “Transgalactosylase” refers to an enzyme that, among other things, is capable of transferring galactose to the hydroxyl groups of D-galactose or D-glucose, thereby producing galactooligosaccharides. The GOS-producing enzyme preferably has a β-galactosidase activity higher than its hydrolytic activity, preferably close to 3000 LAU-C/g.

The GOS-producing enzyme is added in an amount between 20 LAU/g CWP and 60 LAU/g CWP, between 28 LAU/g CWP and 57 LAU/g CWP, which is added to the reaction preferably in an amount of 57 LAU/g CWP or 28 LAU/g CWP.

The reaction time is inversely proportional to the amount of enzyme added to the in situ reaction, preferably 30 to 60 minutes for a concentration of 57 LAU/g lactose, or 120 to 150 minutes for a concentration of 28 LAU/g lactose.

The GOS generated at given times during the reaction can be measured in different ways, such as HPLC analysis, HPAEC-PAD.

After the reaction process, the product obtained is brought to a temperature between 80 and 100° C., preferably a temperature above 90° C., for the purpose of inactivating the GOS-producing enzyme and preventing hydrolysis of the GOS formed and obtaining the GOS ingredient, preferably the temperature is increased for a time between 1 to 10 minutes.

It is suggested that the GOS ingredient be brought to a soluble solids concentration of 65 to 80%, preferably between 70 and 75%, and stored between 10 and 25° C.

Optionally, it is possible to refine the GOS ingredient to further concentrate the solids of interest and obtain a product with a lower amount of sugars through diafiltration processes during nanofiltration of the whey permeate, using membranes with pore sizes that allow separation of GOS from monosaccharides such as glucose and galactose. Additionally, the ingredient can be brought to a solid presentation by drying with known methods.

### GOS Ingredient Formulation

In a second aspect, the disclosure relates to a GOS ingredient formulation, which can be included in the formulation of a food product. The food products in which the GOS ingredient may be included are, among others, products such as dairy beverages, fermented beverages, flavored beverages, ice cream, spreads, sauces, yogurts, and general food products, in addition to products such as dietary supplements, nutraceuticals, special medical purpose foods, infant formulas, and powders for reconstitution.

The GOS ingredient is characterized in that it comprises galacto-oligosaccharides, proteins, minerals, water, and other soluble solids, wherein, for purposes of the present disclosure, the galacto-oligosaccharides have a degree of polymerization (DP) between 2 and 4, with β-(1→3) or β-(1→6) glycosidic linkages.

Galacto-oligosaccharides are present in the GOS ingredient in a concentration of between and 99%, preferably between 45 and 55%, wherein galacto-oligosaccharides with different degrees of polymerization are distributed in DP2 between 1 and 40%, in DP3 between 10 and 50%, and in DP4 between 10 and 60%, more preferably in DP3 between 40 and 50% and in DP4 between 20 and 60%.

Proteins in the GOS ingredient are present in a concentration of between 0.3 and 5%, preferably between 0.3 and 0.5%. Minerals of the GOS ingredient are present between 0.1 and 3%, preferably between 1 and 2%, wherein the minerals comprise potassium, sodium, calcium and phosphorus salts.

Other soluble solids present in the GOS ingredient comprise galactose, glucose, and lactose and are present in a concentration of between 20 and 55%, preferably between 30 and 45% on a dry basis.

It is possible to obtain the GOS ingredient in the form of syrup, refined syrup (diafiltered), or refined powder, wherein the water in the GOS ingredient in syrup or refined syrup form may be in a concentration of between 20 and 40%, preferably between 25 and 35%, and of between 2 and 5% for the refined powder.

To obtain the GOS ingredient in syrup form, it is possible to make a concentration of the GOS ingredient, wherein “syrup” refers to an aqueous solution having 55 to 90° Bx, preferably 70 to 75° Bx.

Research related to the addition of the GOS ingredient in the formulation of a food product contributes to palatability by providing greater sweetness and textures that improve the mouthfeel of users thanks to the sweetening power of oligosaccharides and the increase in soluble solids when water is replaced in the product by the GOS ingredient. Preferably, adding the GOS ingredient to food products does not change the color and may improve flavor and mouthfeel. Application of the GOS ingredient can enhance the nutritional value of the finished product by adding prebiotic fiber, and could improve the organoleptic characteristic of certain products, especially from the dairy industry.

### EXAMPLES

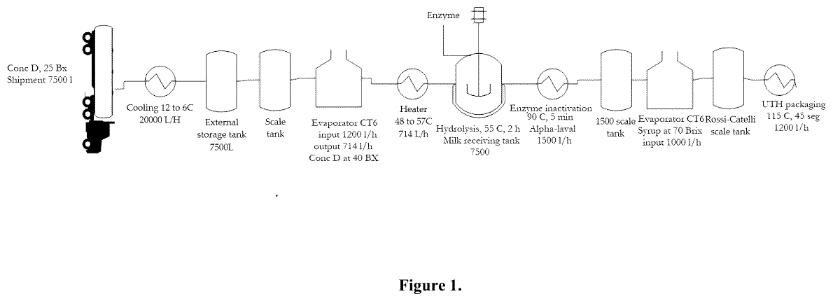

All chemicals and carbohydrates, including glucose, galactose, lactose, maltose, maltotriose, and maltotetraose, were purchased from Merck (USA). A commercial GOS producing enzyme from Bifidobacterium bifidum, with a reported β-galactosidase activity of 3000 LAU-C/g, was used in this study. The GOS -producing enzyme is betagalactosidase with a high transgalactosidase activity superior to the hydrolytic activity. The process for the production of the GOS ingredient is shown in FIG. 1.

### Example 1

### Concentrated Whey Permeate Preparation

Concentrated whey permeate was obtained as a liquid from Alpina Productos Alimenticios S.A. BIC (Colombia). Initially, defatted sweet cheese whey was passed through an ultrafiltration (UF) device (spiral membrane, MWCO 10 kDa) to remove protein and remaining fat in the whey. The permeate, containing carbohydrates (lactose), minerals, and water was then passed through a nanofiltration (NF) device (spiral membrane, 100 Da) to concentrate carbohydrates (rejection coefficient 1), and, to a lesser extent, minerals (rejection coefficient 0.6). The retentate from the NF process was used as raw material for the following steps in this study.

The retentate from UF can contain around 3% protein and can be used as an ingredient in dairy products or as raw material for protein-rich powders commonly used for sport nutrition. The permeate resulting from UF still carries the lactose and minerals in whey; then, by a last step of NF, all the lactose and some minerals can be concentrated in the retentate. This retentate was used as a substrate for GOS production and was known as concentrated whey permeate (CWP).

Table 1 presents the average physicochemical composition of concentrated whey permeate obtained in the production plant of Alpina Productos Alimenticios S.A. BIC under the conditions mentioned above.

TABLE 1
Composition on a wet basis (wb) of concentrated
whey permeate (CWP)

| Component | CWP |
|---|---|
| pH | 6.1 |
| Soluble solids, % wb | 25 |
| Protein | 0.4 |
| Lactose | 20.6 |
| Ash | 1.2 |
| Potassium | 0.28 |
| Sodium | 0.08 |
| Calcium | 0.15 |
| Phosphorous | 0.03 |
| Others | 2.2 |
| Fat, % wb | 0.0 |
| Water, % wb | 75 |

Before proceeding with the enzymatic reaction to generate GOS, concentrated whey permeate solids were further concentrated by evaporation in a rotovap at 50 mbar, 50° C., and 40 rpm, until reaching a lactose concentration close to 30% w/w on a wet basis.

### Example 2

### GOS Production Kinetics

Enzymatic reaction for GOS production was performed in a 10 L bioreactor (Centricol, Medellin, Colombia), with a working volume of 7 L. The reactor was equipped with two Rushton turbines separated by 7 cm and an external jacket for temperature control with steam. Experiments (duplicate) were conducted with 7 L of CWP at 30% lactose. In embodiment A, the enzyme transgalactosidase was added at 57 LAU/g CWP and in embodiment B, the enzyme transgalactosidase was added at 28 LAU/g CWP.

The reaction was run at 55° C., 200 rpm, for 2 hours, taking samples every 0.5 hours to build the kinetics of GOS production. Samples were treated in a water bath at boiling temperature until reaching 90° C. internally and were kept at this condition for 5 min to inactivate the enzyme and avoid hydrolysis of the recently formed GOS. The resulting solution was concentrated in a rotovap at 50 mbar, 50° C., and 40 rpm, until reaching a soluble solids concentration of 75% w/w, to simulate conditions of commercial GOS syrups. Inactivated samples were stored at −20° C. until analysis. An analysis of variance (ANOVA), with a p-value of 0.05, was implemented to determine significant differences in GOS production of the samples taken.

Samples taken during the enzymatic reaction of the E-CWP at 30% lactose were analyzed for galacto-oligosaccharides DP 2 to DP 8. For GOS DP 2, the following molecules were counted as GOS fiber: Allo-lactose (Gal-[1->6]-Glc), Gal-[1->3]-Gal, Gal-[1->3]-Glc, Gal-[1->2]-Glc.

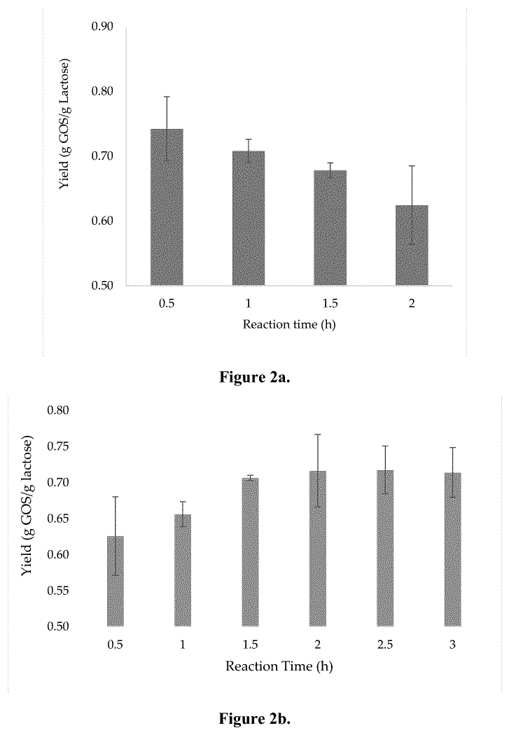

FIG. 2a presents the GOS yield, in embodiment A with the addition of 57 LAU/g solution, expressed as g GOS/g lactose, at the different time points where samples were taken, quantifying the carbohydrate composition by HPAEC-PAD.

FIG. 2b presents the GOS yield, in embodiment B with the addition of 28 LAU/g solution, expressed as mg GOS/g lactose, at the different time points where samples were taken, quantifying the carbohydrate composition by HPAEC-PAD.

The results presented in FIG. 2a indicate that maximum GOS yield in the enzymatic conversion of lactose in concentrate cheese whey was reached at 0.5 hours, and after that time, a decrease in GOS fiber is observed at 1, 1.5 and 2 hours. Even though the statistical analysis did not detect any significant difference in GOS yield during the reaction, it is evident that, under the reaction conditions defined in this experiment, the reaction time that maximizes GOS production is 0.5 hours. From time 0.5 hours to 2 hours, the GOS yield decreased by 16%, which can be explained by the double enzyme activity present in β-galactosidase enzymes, which include transgalactosidase activity, responsible for GOS formation, but also able to hydrolyze lactose and GOS according to the equilibrium of components in solution.

The results presented in FIG. 2b show that the maximum yield of the conversion reaction in GOS occurred after 2.5 hours of reaction. Since a lower enzyme concentration was used, GOS production is expected to present different kinetics, starting with a lower amount of GOS at initial times until reaching a maximum at 2.5 hours, after which a slight decrease is observed due to the hydrolytic activity of the enzyme used, capable of degrading the previously formed GOS.

### Example 3

### Carbohydrate and Mineral Quantification

High performance anion exchange chromatography with pulsed amperometric detection (HPAEC-PAD) on a gold electrode was used for the quantitative analyses of GOS, as well as glucose, galactose, and lactose in the products obtained in embodiments A and B of Example 2.

The analyses were performed with an ICS-5000 DP pump, an AS-AP autosampler, a DC column compartment, and an ED electrochemical detector (Thermo Scientific). A 5 mL sample was injected on a Carbopac PA-1, 250 mm×2 mm, column (Thermo Scientific) thermostated at 30° C. The galactooligosaccharides were eluted at a flow rate of 0.25 mL/min with a linear gradient of 44 mM sodium hydroxide+10 mM sodium acetate to 76 mM sodium hydroxide+80 mM sodium acetate in 48 minutes.

Data analysis was performed with Chromeleon software version 7.2 (Thermo Scientific). Quantitative analyses were carried out using standard solutions of the mono and oligosaccharides (lactose, galactose, glucose, maltose, maltotriose, maltotetraose from Sigma-Aldrich/Merck) and Biotis GOS (Friesland Campina as control sample).

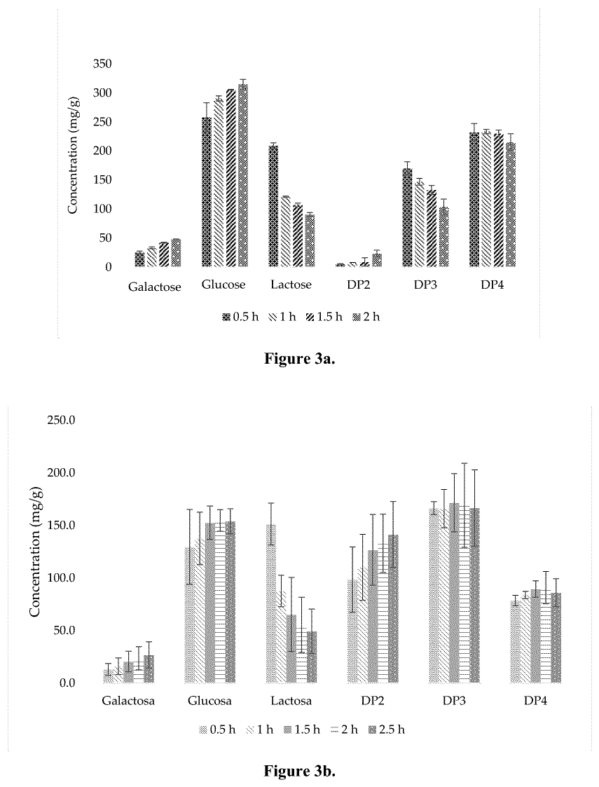

FIGS. 3a and 3b, which represent embodiments A and B, present the distribution of the carbohydrates present in the syrup at each sampling point. The results are expressed in mg of carbohydrates per gram of syrup. The composition presented corresponds to syrups at a soluble solids content of 75% w/w.

As observed in FIGS. 3a and 3b, concentrations of galactose and glucose constantly increase in solution because of the hydrolysis of lactose necessary for GOS production. Glucose concentration is significantly higher than galactose since the former molecule is released from lactose, but at the same time, it is used for GOS formation, while glucose molecules remain free in solution. Lactose concentration decreases over time as result of the hydrolysis process needed for GOS formation.

From FIG. 3a, it is evident that, after the first 0.5 hours, most of the GOS molecules are formed, with a high concentration of GOS DP4, compared to DP2 and DP3. Over time, the concentration of GOS DP4 remains constant, with a slight decrease from 1.5 hours to 2 hours. However, the content of GOS DP3 decreases with time, while DP2 increases slightly with time, but at a lower concentration compared to DP3 and DP4.

FIG. 3b shows that there is a different distribution of DP 2 to 4 compared to the process with a higher amount of enzyme. Here, it is evident that the amount of GOS DP2 increases with time, while the amount of GOS DP3 and GOS DP4 remains constant between 0.5 hours and 3 hours. For this case, the dominant degree of polymerization in solution over time was DP 3, followed by DP 2, and, finally, DP 4. This is due to the change in enzyme concentration leading to a different enzyme-substrate interaction than that observed in the case of higher concentration.

Minerals were quantified by atomic absorption spectrophotometer (Perkin-Elmer model 2380) using hollow cathode lamps. Table 2 shows the mineral composition of the GOS ingredient in the form of syrup after concentration by rotary evaporation. The concentration of minerals is not expected to interfere with the enzymatic reaction for GOS production; therefore, their concentration in solution should be equal for different enzyme doses.

TABLE 2
Theoretical composition of minerals in the GOS ingredient
in syrup form

| | Soluble solids g/100 g | | | | |
|---|---|---|---|---|---|
| % wet basis | 60 | 70 | 80 | 90 | 98 |
| Potassium | 0.67 | 0.78 | 0.90 | 1.01 | 1.10 |
| Sodium | 0.19 | 0.22 | 0.26 | 0.29 | 0.31 |
| Calcium | 0.36 | 0.42 | 0.48 | 0.54 | 0.59 |
| Phosphorous | 0.07 | 0.08 | 0.10 | 0.11 | 0.12 |

TABLE 3
Experimental composition of the minerals in the GOS ingredient at 75%
soluble solids, 2.5 h of reaction, and enzymatic dose of 28 LAU/g CWP.

| | mineral | |
|---|---|---|
| | mg/100 g | Standard |
| Mineral | syrup | deviation |
| Calcium | 551 | 44.5 |
| Sodium | 231 | 5.32 |
| Potassium | 762 | 45.5 |
| Phosphorous | 402 | 20.1 |

### Example 4

### GOS Ingredient Composition

Protein quantification was performed in a LECO-FP528 (St. Joseph, MI), which measures total nitrogen in samples based on the DUMAS method, and a conversion factor of 6.38 was used to calculate total protein. Fat was measured by extraction with petroleum ether (bp 60-80° C.) in a Soxhlet device. Soluble solids were determined with a digital refractometer ATAGO PAL-1 (Tokyo, Japan), adding 1 g of sample to the device. Color was measured in a spectrophotometer Hunter Lab Colorflex EZ (Reston, VI), using the CIELab coordinates: L, a, and b.

TABLE 4
Composition of the GOS ingredient in the form of a syrup
obtained through an enzymatic synthesis with the addition
of 57 LAU/g of transgalactosidase enzyme solution

| | |
|---|---|
| Lactose | 20.9 |
| Glucose | 25.8 |
| Galactose | 2.5 |
| GOS (Fiber) | 40.7 |
| Fat | 0.1 |
| Protein | 1.9 |
| Ash | 3.7 |
| Others | 4.4 |

TABLE 5
Composition of the GOS ingredient in the form of a syrup
obtained through an enzymatic synthesis with the
addition of 28 LAU/g of transgalactosidase enzyme solution

| | |
|---|---|
| Lactose | 5.3 |
| Glucose | 14.8 |
| Galactose | 2.3 |
| GOS (Fiber) | 37.6 |
| Fat | 0 |
| Protein | 1.5 |
| Ash | 3.6 |
| Others | 9.9 |

TABLE 6
Theoretical composition of carbohydrates in the refined GOS syrup

| | |
|---|---|
| Lactose + | 24.7 |
| allolactose | |
| Glucose + | 5.1 |
| Galactose | |
| GOS (Fiber) | 7.2 |

### Example 5

### GOS Application in a Dairy Product

To apply the GOS fiber as an ingredient in a banana porridge product, the GOS syrup was produced in a 10 L bioreactor. The reaction time selected for the enzymatic process was based on the maximum GOS concentration possible according to the reaction kinetics in Section 2.3. After finishing the enzymatic process, the temperature in the reactor was increased to 90° C. for 5 minutes to inactivate the enzyme. The resulting solution was concentrated in a rotovap at 50 mbar, 50° C., and 40 rpm, until reaching a soluble solids concentration of 75% w/w, to simulate conditions of commercial GOS syrups.

Porridge preparation was performed in a 15 kg batch. Two versions of the products were generated: one with the regular formulation used for the product (control) and a second batch with addition of the GOS syrup to reach a dose of 3 g GOS per portion (100 g). Table 7 presents the composition of the control porridge and the GOS-added porridge.

TABLE 7
Formulations of control and GOS-added porridge

| | Porridge | |
|---|---|---|
| Ingredients | Control | GOS-added |
| Water | 65.1% | 58.6% |
| Banana puree | 14.4% | 14.4% |
| Milk | 11.4% | 11.4% |
| Rice flour | 6.7% | 6.7% |
| Starch | 2.1% | 2.1% |
| Whey protein (WPC 80) | 0.3% | 0.3% |
| GOS syrup | | 6.5% |
| Total | 100% | 100% |

The rice flour was mixed with water and heated at 70° C. for 5 minutes, then the banana puree, milk, starch, whey protein, and GOS-syrup were mixed in with the rice flour and water to be heated again, at 70° C. for another 5 minutes. Finally, the porridge was poured into glass flasks and sterilized at 120° C. for 15 minutes.

Physicochemical characteristics, including pH, soluble solids, and color (laboratory coordinates) of the control and GOS-added porridge are presented in Table 8.

TABLE 8
Physicochemical characteristics of original porridge (control)
and GOS-added porridge

| | | | Color | | |
|---|---|---|---|---|---|
| | pH | % SS* | L | a | B |
| Control | 5.97 | 10.7 | 63.05 | 6.29 | 15.31 |
| Porridge + GOS | 5.87 | 16 | 66.55 | 5.12 | 16.72 |

*Percentage of soluble solids

The pH of the control was slightly higher than the GOS-added porridge due to the lower pH of the GOS syrup (5.8) compared to the porridge matrix (5.9-6). However, this change did not significantly modify the organoleptic characteristics of the porridge with GOS. The color also remains very similar between the control and the test, with a small variation on the laboratory coordinates that were not perceived by the human eye. Concentration of soluble solids was the major difference between the samples, increasing by 50% when the GOS syrup is added. This is an expected result since the amount of syrup added, at a soluble solids concentration of 75%, was balanced by removing water (0% soluble solids) from the formulation, which resulted in a higher concentration of soluble solids in the GOS-added porridge.

To evaluate the effect of the changes in pH, color, and soluble solids concentration on the organoleptic characteristics of the control and GOS -added porridge, a blind paired comparison test was performed with ten panelists. Characteristics evaluated were color, odor, flavor, and texture. For the sensory test, ten untrained panelists volunteered to evaluate the samples, which were identified with a 3-digit random number. A scoring sheet was handled to each panelist to select “yes” or “no” if a difference in certain attribute was identified. Finally, a significance test (p-value 0.05) was performed for each attribute to identify statistical differences between the samples presented. Statistically, no perceived difference was noticed in color and odor between the two samples presented. However, with a 0.05 significance level, differences in flavor and texture were noticed by the panelists. Some comments on the flavor of the GOS-added porridge included: “fruit notes are more intense”; “better balance in flavor”; “sweeter, more flavor.” On the other hand, for the texture test, the only comment said “thicker.” This outcome was expected given the sweetener capacity of the syrup, as it contains a significant amount of lactose, glucose, and GOS, all of them with a relative sweetness between 0.3 to 0.7 (when compared to sucrose, 1). Additionally, the higher concentration of soluble solids in the GOS-added porridge, necessarily affects the texture and mouthfeel of the product, which was perceived as an improvement by the panelists.

In general, the results obtained from the sensory evaluation can be consider successful, since parameters such as color and odor were not negatively affected by the application of the GOS syrup; on the contrary, texture and flavor were improved by the addition of this functional ingredient. Application of the GOS syrup can enhance the nutritional value of the finished product by adding prebiotic fiber and could improve the organoleptic characteristic of certain products, especially from the dairy industry.

1. An enzymatic process to obtain a GOS ingredient from whey permeate comprising:
a) ultrafiltering (UF) sweet cheese whey to obtain a whey permeate and a retentate;
b) nanofiltering the whey permeate obtained in step (a) to obtain a retentate (CWP);
c) reacting the retentate (CWP) with β-galactosidase until a dilute GOS ingredient is obtained;
d) inactivating the (3-galactosidase of the diluted GOS ingredient; and
e) obtaining a concentrated GOS ingredient.

2. The process according to claim 1, wherein the sweet cheese whey is characterized by having a pH between 6 and 7, lactose between 3 and 4%, protein between 0.2 and 1%, ash between 0.5 and 1.5%, soluble solids between 3 and 8%, and total solids between 3 and 7%.

3. The process according to claim 1, wherein the whey permeate comprises carbohydrates, minerals, and water.

1. he process according to claim 1, wherein the CWP is concentrated by rotary evaporation to a lactose concentration between 25 to 35% on a wet basis.

5. The process according to claim 1, wherein the β-galactosidase consists of a Bifidobacterium bifidum transgalactosylase enzyme capable of hydrolyzing lactose molecules and polymerizing galactose oligomers, and is added in an amount between 20 LAU/g solution to 60 LAU/g solution.

6. The process according to claim 1, wherein in step (c) the reaction time is between 0.1 and 4 hours.

7. The process according to claim 1, wherein in step (d) the enzyme is inactivated by increasing the temperature to a temperature between 80 to 100° C. in 1 to 10 minutes.

8. The process according to claim 1, wherein the reaction takes place at a temperature of 50 to 55° C., with stifling, for 0.1 and 5 hours.

9. The process according to claim 1, further comprising the step of diafiltrating the concentrated GOS ingredient.

10. A GOS ingredient from whey permeate comprising:
protein between 0.3 and 5%;
minerals between 0.1 and 3%;
water between 50 and 80% (75%);
galacto-oligosaccharides (GOS) between 30 and 99%;
optionally, other soluble solids between 10 and 75%.

11. The GOS ingredient according to claim 10, wherein the GOS ingredient has a degree of polymerization between DP2 and DP4.

10. The GOS ingredient according to claim 10, characterized in that it contains DP2 (1-40%), DP3 (10-50%), and DP4 (10-60%).

13. The GOS ingredient of claim 10, wherein the other soluble solids comprise galactose, glucose, and lactose.

14. The GOS ingredient of claim 10, wherein the minerals comprise potassium, sodium, calcium and phosphorus salts.
